(19) United States
(12) Patent Application Publication
(10) Pub. No.: US 2022/0363889 A1
(43) Pub. Date: Nov. 17, 2022

(54) THERMOPLASTIC RECYCLING MOLDING COMPOSITION BASED ON RECYCLED ACRYLONITRILE-BUTADIENE-STYRENE COPOLYMERS AND PROCESS FOR ITS PREPARATION

(71) Applicant: INEOS STYROLUTION GROUP GMBH, Frankfurt am Main (DE)

(72) Inventors: Oliver CARSTENSEN, Frankfurt (DE); Norbert NIESSNER, Friedelsheim (DE); Eike JAHNKE, Frankfurt am Main (DE); Yvonne van VEEN, Uithoorn (NL)

(21) Appl. No.: 17/767,299

(22) PCT Filed: Oct. 12, 2020
(86) PCT No.: PCT/EP2020/078646

§ 371 Date: Apr. 7, 2022

(30) Foreign Application Priority Data
Oct. 15, 2019 (EP) 19203404.9

(51) Int. Cl. C08L 55/02; C08L 25/12; C08L 53/02

(52) U.S. Cl. CPC C08L 55/02; C08L 25/12; C08L 53/02; C08L 2207/20; C08L 2205/025; C08L 2205/03; C08L 2203/30

(57) ABSTRACT

The invention is directed to a thermoplastic recycling molding composition comprising recycled acrylonitrile-butadiene-styrene copolymer (r-ABS) as component A and virgin material as component B, wherein the component B is a mixture of at least two components selected from virgin thermoplastic polymers B1 and virgin lubricants B2, or wherein the component B is one or more polymer selected from polymers which are not homogenously miscible with rABS. Further, the present invention is directed to a process for the preparation of the thermoplastic recycling molding composition.

The present invention relates to a thermoplastic recycling molding composition comprising recycled acrylonitrile-butadiene-styrene copolymer (r-ABS) as component A and virgin material as component B, wherein the component B is a mixture of at least two components selected from virgin thermoplastic polymers B1 and virgin lubricants B2, or wherein the component B is one or more polymer selected from polymers which are non-homogenously miscible with rABS. Further, the present invention deals with a process for the preparation of the thermoplastic recycling molding composition.

Furthermore, the present invention deals with a process for the production of a recycling polymer compositions comprising recycled acrylonitrile-butadiene-styrene copolymer (r-ABS) and virgin material B, wherein defined key properties of the recycled acrylonitrile-butadiene-styrene copolymer (r-ABS) are measured and the amount and the composition of the virgin material B are determined based on pre-defined ranges of target properties and using a screening method based on Design of Experiment (DoE).

Products made from or incorporating plastic are part of almost any work place or home environment. Most of these plastics are virgin polymers that are produced from petroleum. In the recent years, there has been a strong movement to recycle and reuse petrochemical products, such as plastics, in addition to metallic material. Recycling plastic from waste plastic materials has a variety of benefits compared to producing virgin plastic from petroleum, e.g. less energy is required, the need for disposing waste material is reduces, and the use of limited geological resources, such as petroleum, is reduced. Typically, waste plastic materials include post-consumer and post-industrial waste materials and plastic scrap. Some of the most common polymer types in waste plastic materials from durable goods are acrylonitrile-butadiene-styrene copolymers (ABS), high impact polystyrene (HIPS), polypropylene (PP) and polycarbonate (PC).

Durable goods, such as automobile equipment, appliance and electronic equipment, represents a significant portion of municipal waste and are increasingly being collected at the end of their lives and partly recycled in order to avoid disposal cost and to recover metals and other marketable raw materials. Generally, the metal content in automobiles, appliances and electronics is higher than the plastics content. Typically, the plastics content in such products is less than 30%. Thus, the metal recovery operation often precedes plastic recovery. Most metal recovery operations shred equipment in order to cost-effectively liberate metals from the durable goods.

The recovery of plastics from durable goods requires a plastic-rich raw material. Typical such plastic rich raw material, which is obtained from metal recyclers or automotive shredder residue, are highly variable mixtures obtained from different types of durable goods, and as a consequence they are highly variable mixtures of different types and grades of polymers. In order to create recycling polymer products having acceptable purity, such raw materials are separated in large-scale plastic recovery operations, e.g. using methods based on separation by density.

WO 2003/086733 describes a process for preparing recycled plastics wherein a plastic rich mixture is separated in multiple steps selected from preprocessing operations, size reduction operations, gravity concentration operations, color sorting, sorting by thickness, friction, or differential terminal velocity or drag in air, surface to mass control operations, separating processes enhanced by narrow surface to mass distribution, blending operations, and extrusion and compounding operations. The process described in WO 2003/086733 may provide a recycled ABS plastic stream, wherein the plastic source may be refrigerators or automation equipment.

Often it is necessary to blend the recycled plastic material with virgin plastic material in order to obtain a recycled product that is equally to the corresponding virgin product (i.e. the product made from virgin polymers), and that can used in injection molding process equally to the corresponding virgin product.

U.S. Pat. No. 6,881,368 describes a process wherein recycled ABS, typical obtained from electric and electronic equipment is blended with at least one resin selected from polycarbonate, polyvinyl chloride and/or polybutylene terephthalate.

US 2011/0224322 describes a blend of recycled thermoplastic resins comprising a primary polymer, such as polyethylene, one or more secondary polymers, such as impact modified styrene acrylonitrile copolymers polystyrene, impact modified polystyrene, polyethylene, and additives such as antioxidants, heat stabilizers, UV stabilizers, flame retardants, antistatic agents, blowing agents, impact modifiers, compatibilizers, fillers, fiber reinforcements, fluorescent whiteners, and lubricants. The blend of US 2011/0224322 is at least in parts recovered from waste plastic, e.g. waste plastic derived from office automation equipment, white goods, consumer electronics, automotive shredder residue, building waste and post-industrial molding and extrusion scrap.

EP-A 2177333 describes a method for reprocessing recycled ABS resin, wherein the recycled ABS resin is mixed with a unused ABS resin B and/or other used ABS resin C in order to improve the physical properties of the ABS resin.

In particular, the amount of the ABS resin B and C is selected so that the value obtained from the following formula 1 is equivalent to or higher than the impact resistance required for the resulting ABS resin:

Formula 1=[Content of used ABS resin (A)]×[Impact resistance of used ABS resin (A)]+[Content of unused ABS resin (B)]×[Impact resistance of unused ABS resin (B)]+[Content of used ABS resin (C)]×[Impact resistance of used ABS resin (C)]

In order to obtain recycled plastic materials with high quality and consistency of properties, that can be used in high quality applications, e.g. for use in electronic and automobile equipment, it is necessary to improve the recycling process and to provide recycling products that can be used equally to the corresponding virgin polymer product.

It was surprisingly found that optimal mixtures of recycled ABS and different virgin materials can be obtained by using a defined screening method based on Design of Experiment (DoE). Furthermore, it was surprisingly found that the addition of at least two different virgin materials is required to adjust the properties of recycled ABS (rABS) in such way that the blends obtained are within a pre-defined corridor of mechanical, thermal and flow properties. In particular, it was found that the addition of at least two virgin materials selected from acrylonitrile-butadiene-styrene copolymers (ABS), styrene-acrylonitrile copolymers (SAN), styrene-butadiene block copolymers (SBC) and lubricants B2, is advantageous to obtain a recycled ABS product with high and consistent quality having a good balance of the required properties.

Furthermore, it was surprisingly found that it is possible to improve or adjust the properties of recycled ABS (rABS) by the addition of one or more polymers that are non-homogenously miscible with rABS, for example SBC, mass-ABS or ethylene copolymers. It was found that the impact resistance and the toughness of rABS can be significantly improved by the addition of such non-miscible polymers.

### Description of the Invention

The present invention is directed to a thermoplastic recycling molding composition, comprising
A. from 10 to 90% by weight, preferably 30 to 80% by weight, also preferably from 10 to 55% by weight, based on the total composition, of at least one recycled acrylonitrile-butadiene-styrene copolymer (rABS) as component A; and
B. from 10 to 90% by weight, preferably 20 to 70% by weight, also preferably from 45 to 90% by weight, based on the total composition, of virgin material as component B, wherein the virgin material B is a mixture of at least two components selected from virgin polymers B1, preferably selected from acrylonitrile-butadiene-styrene copolymers (ABS), styrene-acrylonitrile copolymers (SAN), and styrene-butadiene block copolymers (SBC), and virgin lubricants B2, preferably selected from fatty acids, fatty acid esters, fatty acid salts, fatty acid amides and hydrocarbon waxes, or wherein the virgin material B comprises one or more polymers which are non-homogenously miscible with the recycled acrylonitrile-butadiene-styrene copolymer (rABS).

In a preferred embodiment the present invention is directed to a thermoplastic recycling molding composition comprising
A. from 40 to 90% by weight, preferably from 50 to 70% by weight, based on the total composition, of the at least one recycled acrylonitrile-butadiene-styrene copolymer (rABS) as component A; and
B. from 10 to 60% by weight, preferably from 30 to 50% by weight, based on the total composition, of the virgin material as component B, wherein the virgin material B is a mixture of at least two components selected from virgin polymers B1, preferably selected from acrylonitrile-butadiene-styrene copolymers (ABS), styrene-acrylonitrile copolymers (SAN), and styrene-butadiene block copolymers (SBC), and virgin lubricants B2, preferably selected from fatty acids, fatty acid esters, fatty acid salts, fatty acid amides and hydrocarbon waxes.

In particular the present invention provides an improved post-consumer recycling product based on acrylonitrile-butadiene-styrene copolymers and a method for its preparation.

In terms of the present invention “virgin material” means a material, which is made from geological resources, and is not made from existing and in particular used material. In terms of the present invention virgin polymer material means a polymer, which is made from geological resources, such as petroleum, and is not made from existing and in particular used plastic material.

In terms of the present invention recycled acrylonitrile-butadiene-styrene copolymer (rABS) means polymer from type acrylonitrile-butadiene-styrene copolymer that is prepared from waste plastic material, in particular from recycled durable goods, typically in a recycling and separation process.

In terms of the present invention “durable goods” or “recycled durable goods” means goods, such as household appliance, machinery, sport equipment, consumer electronics, and automobiles, that are not consumed or destroyed quickly in use, but are expected to last and yields utility a long time, in particular three or more years. In particular the term “post-consumer products” or “post-consumer durable goods” refer to products or goods after their intended use, in particular after their use for three or more years, e.g. such material is collected and recycled in form of waste plastic material.

Recycled ABS/NABS (Component A)

Preferably, the recycled acrylonitrile-butadiene-styrene copolymer (rABS) used as component A is a recycling material obtained from the recycling of durable goods, in particular of post-consumer durable goods, preferably selected from automobile equipment, household appliance and electrical equipment.

Typically, durable goods are being understood as goods, such as household appliance, machinery, sport equipment, consumer electronics, and automobiles, that are not consumed or destroyed quickly in use, but are expected to last and yields utility a long time, in particular three or more years.

Preferably, the recycled acrylonitrile-butadiene-styrene copolymer (rABS) comprises at least 90% by weight, based on rABS, of acrylonitrile-butadiene-styrene copolymer type polymers. The recycled acrylonitrile-butadiene-styrene copolymer (rABS) can for example be a mixture of different grades of acrylonitrile-butadiene-styrene copolymers or the rABS component A can be composed of one grade of rABS. For example the rABS component can be obtained from scrap and rejected parts from a manufacturing process of ABS-moldings.

Typically, a grade of a polymer is a formulation of the polymer of the given polymer type with a particular set of defined physical characteristics or properties (property profile). Different grades of polymer materials may differ in molecular weight, molecular weight distribution, polymer structure, and additives. Different grades of a given polymer type are generally compatible and can be melt mixed to create a new material with a different property profile. Generally, different types of polymers cannot mixed in molten form unless they are compatible types.

In a preferred embodiment the recycled acrylonitrile-butadiene-styrene copolymer (rABS) exhibits one or more (e.g. two to eight) of the following properties:
Melt volume flow rate (MVR) (measured on a polymer melt at 220° C. and 10 kg load according to ISO 1133-1:2011) in the range of 10 to 35 cm³/10 min,
Vicat temperature (Vicat B/50 measured according to ISO 306:2004) of more than or equal to 80° C., preferably in the range of 80 to 100° C.,
E-modulus (measured in accordance with ISO 527) of more than 1500 MPa, preferably more than 2000 MPa;
Stress at yield (measured with ISO 527) in the range of 30 to 50 MPa,
Strain at yield (measured with ISO 527, 2012) in the range of 2 to 3%,
Elongation at break (measured in accordance with ISO 527) in the range of 5 to 15%, preferably 5 to 7%,
Charpy Notched Impact Strength at 23° C. (measured in accordance with EN-ISO 179-1, (e.g. 2010) notch type A) in the range of 2 to 20 kJ/m²,
Charpy Notched Impact Strength at -30° C. (measured in accordance with EN-ISO 179-1, notch type A) in the range of 2 to 20 kJ/m².

Virgin Material B

In a preferred embodiment, the virgin material B comprises one or more polymers which are not miscible with the recycled acrylonitrile-butadiene-styrene copolymer (rABS). Preferably, such non-miscible polymers are selected from styrene-butadiene block copolymers (SBC), ethylene copolymers, such as ethylene-acrylate copolymers or ethylene-butylene-styrene copolymers, and mass-ABS. Typically in this preferred embodiment the virgin material B is a component which is non-homogeneously miscible with the recycling-ABS.

In this preferred embodiment the styrene-butadiene block copolymers (SBC) is preferably selected from commercially available styrene-butadiene block copolymer, such as Styroflex® or Styrolux® type products from INEOS Styrolution (Frankfurt, Germany), e.g. Styroflex® 2G 66. The styrene-butadiene block copolymer (SBC) is e.g. obtainable by anionic polymerization, as described, for example, in WO 96/20248 and WO 97/40079. Preferably, the ethylene copolymer is selected from ethylene-acrylate copolymers (e.g. Elvaloy® 1224, from DuPont), or from ethylene-butylene-styrene copolymers (e.g. Calprene® 6170 from Dynasol), and mass-ABS (e.g. Magnum 3904 from Trinseo).

In term of the present invention two or more polymers are homogeneously miscible, if only one glass transition temperature T_{g} can be detected (e.g. using Dynamic Scanning calorimetry DSC) for the blend of the two or more polymers. In particular the blend of two or more homogenously miscible polymers is a single phase composition.

In term of the present invention two or more polymers are non-homogeneously miscible, if more than one glass transition temperature T_{g} can be detected (e.g. using Dynamic Scanning calorimetry DSC) for the blend of the two or more polymers.

It was surprisingly found that it is advantageous to add non-homogeneously miscible polymer components on order to improve the properties of recycling ABS. Examples of such non-homogeneously miscible components are acrylonitrile-styrene-acrylate copolymers (ASA, e.g. Luran® S), styrene-butadiene block copolymers (e.g. Styroflex®, Styrolux®, K-Resin®), mass-ABS with different acrylonitrile content compared to the recycling ABS, ethylene-copolymers, ethylene copolymers with polar co-monomers, like acrylates (e.g. Elvaloy®), polycarbonates, thermoplastic polyurethanes, and polymethyl methacrylates.

In another preferred embodiment the virgin material B is a mixture of at least two components selected from virgin thermoplastic polymers B1, selected from acrylonitrile-butadiene-styrene copolymers (ABS), styrene-acrylonitrile copolymers (SAN), and styrene-butadiene block copolymers (SBC), and virgin lubricants B2, selected from fatty acids, fatty acid esters, fatty acid salts, fatty acid amides and hydrocarbon waxes.

In particular the virgin material B is a mixture of at least two components selected from virgin thermoplastic polymers B1, selected from acrylonitrile-butadiene-styrene copolymers (ABS), styrene-acrylonitrile copolymers (SAN), and styrene-butadiene block copolymers (SBC), and virgin lubricants B2, selected from ethylene bis(stearylamide) (EBS) and/or penta-erythrityl tetra-stearate (PETS).

It is also preferred that the mixture of at least two components selected from virgin thermoplastic polymers B1 and virgin lubricants B2 comprises at least one non-homogeneously miscible polymer as described above.

In a preferred embodiment the virgin material B is a mixture of 2 to 10, preferably 2 to 8, more preferably 2 to 6, more preferably 3 to 5 components B, preferably selected from virgin thermoplastic polymers B1, selected from acrylonitrile-butadiene-styrene copolymers (ABS), styrene-acrylonitrile copolymers (SAN), and styrene-butadiene block copolymers (SBC), and virgin lubricants B2; more preferably selected from acrylonitrile-butadiene-styrene copolymers (ABS), styrene-acrylonitrile copolymers (SAN), styrene-butadiene block copolymers (SBC), ethylene bis(stearylamide) (EBS) and/or pentaerythrityl tetrastearate (PETS).

Preferably, the virgin material B comprises at least one virgin thermoplastic polymer B1, in particular selected from acrylonitrile-butadiene-styrene copolymers (ABS), styrene-acrylonitrile copolymers (SAN), and styrene-butadiene block copolymers (SBC). In a further preferred embodiment the virgin material B is a mixture of the virgin thermoplastic polymers B1, which are at least one acrylonitrile-butadiene-styrene copolymer (ABS), at least one styrene-acrylonitrile copolymer (SAN), and at least one styrene-butadiene block copolymer (SBC), and one or more virgin lubricants B2, preferably selected from fatty acids, salts of fatty acids, fatty acid esters, and fatty acid amide derivatives.

Preferably the virgin material B comprises at least one virgin thermoplastic polymer B1 and at least one virgin lubricant B2.

In a further preferred embodiment the virgin material B is a mixture of virgin acrylonitrite-butadiene-styrene copolymer (ABS) and at least one other component B, preferably selected from virgin styrene-acrylonitrile copolymers (SAN), virgin styrene-butadiene block copolymers (SBC), and virgin lubricants B2, selected from fatty acids, fatty acid esters, fatty acid salts, fatty acid amides and hydrocarbon waxes, preferably selected from ethylene bis(stearylamide) (EBS) and/or pentaerythrityl tetrastearate (PETS).

In a further preferred embodiment the virgin material B is a mixture of virgin acrylonitrile-butadiene-styrene copolymer (ABS), virgin styrene-acrylonitrile copolymers (SAN), virgin styrene-butadiene block copolymers (SBC), and at least one virgin lubricant B2, preferably selected from ethylene bis(stearylamide) (EBS) and/or pentaerythrityl tetrastearate (PETS), wherein ethylene bis(stearylamide) (EBS) is more preferred.

Preferably, the virgin material B comprises from 10 to 80% by weight, preferably 50 to 75%, based on the total virgin material B, of at least one virgin acrylonitrile-butadiene-styrene copolymer (ABS). In another preferred embodiment the virgin material B comprises from 10 to 50% by weight, preferably 10 to 45%, based on the total virgin material B, of at least one virgin acrylonitrile-butadiene-styrene copolymer (ABS).

In particular the virgin material B is a mixture of at least two components of:

from 0 to 80% by weight, preferably 0 to 75% by weight, based on the total virgin material B, of at least one virgin acrylonitrile-butadiene-styrene copolymer (ABS), from 0 to 40% by weight, preferably 0 to 30% by weight, based on the total virgin material B, of at least one virgin styrene-acrylonitrile copolymers (SAN),

from 0 to 25% by weight, preferably 0 to 15% by weight, based on the total virgin material B, of at least one styrene-butadiene block copolymers (SBC), from 0 to 8% by weight, preferably 0 to 7% by weight, based on the total virgin material B, of at least one virgin lubricant B2, preferably selected from ethylene bis(stearylamide) (EBS) and pentaerythrityl tetrastearate (PETS), more preferably ethylene bis(stearylamide) (EBS).

In a preferred embodiment the virgin material B comprises (or preferably consists of):

from 20 to 75% by weight, preferably from 30 to 70% by weight, based on the total virgin material B, of at least one virgin acrylonitrile-butadiene-styrene copolymer (ABS),

from 5 to 40% by weight, preferably from 10 to 30% by weight, based on the total virgin material B, of at least one virgin styrene-acrylonitrile copolymers (SAN),

from 0.5 to 20% by weight, preferably from 1 to 15% by weight, based on the total virgin material B, of at least one styrene-butadiene block copolymers (SBC),

from 0.1 to 10% by weight, preferably from 0.5 to 8% by weight, based on the total virgin material B, of at least one virgin lubricant B2, preferably selected from ethylene bis(stearylamide) (EBS) and pentaerythrityl tetrastearate (PETS), more preferably ethylene bis(stearylamide) (EBS).

In a preferred embodiment the virgin material B comprises (or preferably consists of):

from 50 to 95% by weight, preferably from 60 to 90% by weight, based on the total virgin material B, of at least one virgin acrylonitrile-butadiene-styrene copolymer (ABS),

from 1 to 30% by weight, preferably from 5 to 20% by weight, based on the total virgin material B, of at least one styrene-butadiene block copolymers (SBC),

from 0.1 to 20% by weight, preferably from 1 to 15% by weight, based on the total virgin material B, of at least one virgin lubricant B2, preferably selected from ethylene bis(stearylamide) (EBS) and pentaerythrityl tetrastearate (PETS), more preferably ethylene bis(stearylamide) (EBS).

Virgin Polymer B1

In a preferred embodiment, the virgin material B comprises at least one acrylonitrile-butadiene-styrene copolymer (ABS), for example products from the series Terluran® or Novodur® (from INEOS Styrolution).

In a preferred embodiment, the virgin material B comprises at least one styrene-acrylonitrile copolymer (SAN), in particular a non-rubber-modified styrene-acrylonitrile copolymer, for example one of Luran® type products from INEOS Styrolution(Frankfurt, Germany).

Suitable SAN copolymers may comprise (or consists of):

from 50 to 95% by weight, preferably from 65 to 80% by weight, particularly preferably from 69 to 80% by weight, also preferably from 71 to 80% by weight, based on the SAN copolymer, of at least one monomer selected from styrene, α-methylstyrene and mixtures of styrene and α-methylstyrene, and

from 5 to 50% by weight, preferably from 20 to 35% by weight, particularly preferably from 20 to 31% by weight, also preferably from 20 to 29% by weight, based on the SAN polymer of a monomer selected from acrylonitrile and mixtures of acrylonitrile and methacrylonitrile.

Typically, the average molar mass M_{w} of suitable SAN copolymers is from 80 000 to 350 000 g/mol, preferably from 100 000 to 300 000 g/mol and particularly preferably from 120 000 to 250 000 g/mol.

In a preferred embodiment, the virgin material B comprises at least one styrene-butadiene block copolymer (SBC), for example a commercially available styrene-butadiene block copolymer, such as Styroflex® or Styrolux® type products from INEOS Styrolution (Frankfurt, Germany), e.g. Styroflex®2G 66.

For example the styrene-butadiene block copolymer (SBC) is obtainable by anionic polymerization, as described, for example, in WO 96/20248 and WO 97/40079.

Virgin Lubricant B2

Preferably, the virgin lubricant B2 is selected from long-chain fatty acids, such as stearic acid or behenic acid, salts of fatty acids (e.g. calcium stearate or zinc stearate), esters of fatty acids (e.g. stearyl stearate or pentaerythrityl tetrastearate), amide derivatives of fatty acids (e.g. ethylenebisstearylamide, erucamide, Acrawax®), phosphates (such as tricalcium phosphate), hydrocarbon waxes, such as microcrystalline waxes and paraffin waxes (e.g. Besquare®), and fumed silica (e.g. Aerosil®). Typically fatty acids are carboxylic acids having a linear or branched, saturated or unsaturated C₅-C₂₅ alkyl chain.

More preferably, the virgin lubricant B2 is at least one compound selected from fatty acids, salts of fatty acids, fatty acid esters, and fatty acid amide derivatives, more preferably selected from stearic acid, stearates, stearic acid esters and stearic acid amides.

Preferably, the virgin lubricant B2 is at least one compound selected from fatty acid esters and fatty acid amide derivatives, more preferably selected from stearic acid esters and stearic acid amide derivatives. In particular B2 is ethylene bis(stearylamide) (CAS-No. 110-30-5) (EBS) and/or pentaerythrityl tetrastearate (CAS-No. 115-83-3) (PETS). Typically ethylene bis(stearylamide) (EBS) and pentaerythrityl tetrastearate (PETS) are in form of waxy solids (EBS wax, PETS wax).

Preferably, the virgin material B can comprise up to 15% by weight, preferably up to 10% by weight, based on the total virgin material B, of the at least one virgin lubricant B2.

In a preferred embodiment the virgin lubricant B2 is ethylene-bis-stearylamide (EBS). Preferably, the virgin material B comprises ethylene-bis-stearylamide (EBS) as component B2, in an amount from 0.1 to 8% by weight, preferably 0.5 to 7% by weight, based on the total virgin material B.

Additives C

The thermoplastic recycling molding composition may comprise up to 10% by weight, preferably up to 5% by weight, based on the total thermoplastic recycling molding composition,, of one or more additional additive C, which is different from B2. Preferably, the molding composition may comprise from 0.01 to 10% by weight, preferably 0.1 to 5, more preferably 0.1 to 2.5% by weight, based on the total thermoplastic recycling molding composition, of one or more additives C.

Further, the inventive molding composition may comprise commonly known additives which originate from the recycled acrylonitrile-butadiene-styrene copolymer (rABS), but which are not included in the amount described for additive C.

The additional additive is typically selected from commonly known additives for styrene polymers and copolymers and compositions thereof.

Substances that can be used as additives or auxiliaries are the polymer additives known to the person skilled in the art and described in the prior art (e.g. Plastics Additives Handbook, ed. Schiller et al., 6^{th} Ed, 2009, Hanser). The additive and/or auxiliary can be added either before or during the compounding procedure (mixing of the polymeric components A and B in the melt).

The molding compositions may comprise, as component C, from 0.01 to 5% by weight of usual additives, such as processing aids, stabilizers, oxidation inhibitors, ultra-violet light absorbers, flame retardants, colorants, pigments, and plasticizers.

Examples of oxidation inhibitors and heat stabilizers are sterically hindered phenols, various substituted representatives of these groups and mixtures thereof in concentrations of up to 1% by weight, based on the total thermoplastic recycling molding composition.

UV stabilizers which may be mentioned, and are generally used in amounts of up to 2% by weight, based on the total thermoplastic recycling molding composition, are various substituted resorcinols, salicylates, benzotriazoles and benzophenones.

Preferred is the use of a stabilizer, in particular oxygen radical scavengers such as Irganox® 1010 (BASF SE), Songnox® 1010, Irganox 1076, Irganox 565 and blends thereof, carbon radical scavengers such as Sumilizer® GS, Sumilizer GM and blends thereof, and/or secondary stabilizers such as Irgafos® 168 (BASF SE). Said stabilizers are commercially available. The afore-mentioned stabilizers are preferably used in amounts of 0.01 to 0.5 wt.-%, more preferably 0.1 to 0.3 wt.-%, based on the total thermoplastic recycling molding composition.

An example of a processing aid, which can be used in amounts from 0.1 to 5% by weight, preferably from 0.5 to 3% by weight, based on the total thermoplastic recycling molding composition, is a homogeneously miscible oil or oil mixture, in particular selected from mineral oils (medical grade mineral oil), vegetable oils (also referred to as plant oils) and silicon oils.

Thermoplastic Recycling Molding Composition

In a preferred embodiment, the thermoplastic recycling molding composition comprises (or preferably consists of):

from 19.4 to 39.4% by weight, preferably from 20 to 30% by weight, based on the total composition, of at least one recycled acrylonitrile-butadiene-styrene copolymer (rABS); and

from 30 to 75% by weight, preferably from 40 to 60% by weight, based on the total composition, of at least one virgin acrylonitrile-butadiene-styrene copolymer (ABS),

from 5 to 25% by weight, preferably from 10 to 20% by weight, based on the total composition, of at least one virgin styrene-acrylonitrile copolymer (SAN),

from 0.5 to 15% by weight, preferably from 1 to 10% by weight, based on the total composition, of at least one styrene-butadiene block copolymer (SBC),

from 0.1 to 7% by weight, preferably from 0.5 to 5% by weight, based on the total composition, of at least one virgin lubricant B2, preferably selected from ethylene bis(stearylamide) (EBS) and pentaerythrityl tetrastearate (PETS), more preferably ethylene bis(stearylamide) (EBS), and

optionally from 0 to 5% by weight, preferably 0 to 2% by weight, based on the total composition, of one or more additive C.

In another preferred embodiment the thermoplastic recycling molding composition comprises (or preferably consists of):

from 40 to 80% by weight, preferably from 45 to 55% by weight, based on the total composition, of at least one recycled acrylonitrile-butadiene-styrene copolymer (rABS); and

from 10 to 50% by weight, preferably from 20 to 40% by weight, based on the total composition, of at least one virgin acrylonitrile-butadiene-styrene copolymer (ABS),

from 1 to 30% by weight, preferably from 5 to 20% by weight, based on the total composition, of at least one virgin styrene-acrylonitrile copolymer (SAN),

from 1 to 20% by weight, preferably from 2 to 10% by weight, based on the total composition, of at least one styrene-butadiene block copolymer (SBC),

from 1 to 5% by weight, preferably from 2 to 4% by weight, based on the total composition, of at least one virgin lubricant B2, preferably selected from ethylene bis(stearylamide) (EBS) and pentaerythrityl tetrastearate (PETS), more preferably ethylene bis(stearylamide) (EBS), and

optionally from 0 to 5% by weight, preferably 0 to 2% by weight, based on the total composition, of one or more additive C.

In another preferred embodiment the thermoplastic recycling molding composition comprises (or preferably consists of):

from 40 to 80% by weight, preferably from 45 to 75% by weight, based on the total composition, of at least one recycled acrylonitrile-butadiene-styrene copolymer (rABS); and

from 10 to 50% by weight, preferably from 20 to 40% by weight, based on the total composition, of at least one virgin acrylonitrile-butadiene-styrene copolymer (ABS),

from 0 to 20% by weight, preferably from 0 to 15% by weight, more preferably 1 to 15% by weight, based on the total composition, of at least one virgin styrene-acrylonitrile copolymer (SAN),

from 0 to 20% by weight, preferably 1 to 20% by weight, more preferably from 1 to 15% by weight, based on the total composition, of at least one styrene-butadiene block copolymer (SBC),

from 1 to 5% by weight, preferably from 2 to 4% by weight, based on the total composition, of at least one virgin lubricant B2, preferably selected from ethylene bis(stearylamide) (EBS) and pentaerythrityl tetrastearate (PETS), more preferably ethylene bis(stearylamide) (EBS), and

optionally from 0 to 5% by weight, preferably 0 to 2% by weight, based on the total composition, of one or more additive C.

Process for Preparing the Thermoplastic Recycling Molding Compositions

Furthermore, the present invention is directed to a process for preparing the inventive thermoplastic recycling molding composition. In particular the invention is directed to a process for preparing the inventive thermoplastic recycling molding composition as described above, wherein the components A and B and optionally C, are melt compounded at a temperature in the range of 180 to 280° C., preferably 200 to 250° C.

The thermoplastic recycling molding composition may be prepared by processes known per se. For example extruders, such a co-rotating or counter rotating single- or twin screw extruders, or other conventional kneading apparatuses, such as continuous or batch kneaders, Brabender mixers or Banbury mixers, may be used for preparing the molding composition. Said kneading elements should ensure sufficient homogenization of the components guaranteeing micro mixing. The inventive thermoplastic recycling molding composition may be obtained by mixing and homogenization the components by the usual methods of plastic technology, wherein the sequence of adding the components may be varied.

Preferably, the recycled ABS component A may be pre-treated before the melt compounding with component B, e.g. via homogenization, grinding, crushing, and/or micronization.

Moldings Made from the Thermoplastic Recycling Molding Compositions

Further, the present invention is directed to the use of the inventive thermoplastic recycling molding composition described above for the preparation of moldings (sharped articles) for various applications, e.g. applications in automotive sector, electronics, household articles, constructions, healthcare articles, packaging, sports and leisure articles. The thermoplastic recycling molding composition of the invention can be used for the production of moldings of any type. These can be produced via injection molding, extrusion and blow molding processes. Another type of processing is the production of moldings via thermoforming from sheets or films previously produced, and the process of film-overmolding. In particular the inventive thermoplastic recycling molding composition is used in an injection molding process. Examples of these moldings are films, profiles, housing parts of any type, e.g. for household devices such as juice presses, coffee machines, mixers; for office equipment such as monitors, printers, copiers; exterior and interior parts of automobiles; sheets, pipes, electrical installation ducts, windows, doors and other profiles for the construction sector (fitting-out of interiors and outdoor applications), and also parts for electrical and electronic uses, such as switches, plugs and sockets.

Further, the present invention is directed to moldings made of the inventive thermo-plastic recycling molding composition described above. The moldings can be selected from moldings of any type, for example as described above. In particular, the moldings can be for example parts for the fitting-out of interiors of rail vehicles, ships, aircraft, buses and other motor vehicles, bodywork components for motor vehicles, housings of electrical equipment containing small transformers, housings for equipment for the processing and transmission of information, housings and cladding for medical equipment, massage equipment and housings therefor, toy vehicles for children, sheet-like wall elements, housings for safety equipment, thermally insulated transport containers, apparatus for the keeping or care of small animals, moldings for sanitary and bath equipment, protective grilles for ventilator openings, moldings for garden sheds and tool sheds, housings for garden equipment.

Process using DoE for Producing a Recycling Polymer Composition

Furthermore, it has been found that the amount and composition of the virgin material B that is necessary to bring the molding composition into a pre-defined range of key properties, can be determined based on selected key properties of the recycled ABS (rABS) using a screening method based on Design of Experiment (DoE).

In this aspect the present invention provides a process for preparing a recycling polymer compositions comprising at least one recycled acrylonitrile-butadiene-styrene copolymer (r-ABS) and a virgin material B, wherein the virgin material B is a mixture of at least two components selected from virgin thermoplastic polymers B1 and virgin lubricants B2, or wherein the virgin material B comprises one or more polymers which are non-homogenously miscible with the recycled acrylonitrile-butadiene-styrene copolymer (rABS), comprising the steps of:
a. Homogenization of the at least one recycled acrylonitrile-butadiene-styrene copolymer (rABS), wherein a batch of recycled acrylonitrile-butadiene-styrene copolymer (rABS) is obtained;
b. Measurement of at least one key property KP of the batch of acrylonitrile-butadiene-styrene copolymer (rABS);
c. Determination of amount and composition of virgin material B based on predefined ranges of target properties TP of the recycling polymer composition and using a screening method based on Design of Experiment (DoE);
d. Mixing the virgin material B as determined in step c and the batch of recycled acrylonitrile-butadiene-styrene copolymer (rABS).

In a preferred embodiment the virgin material B used in the inventive process is a mixture of at least two components selected from virgin thermoplastic polymers B1, selected from acrylonitrile-butadiene-styrene copolymers (ABS), styrene-acrylonitrile copolymers (SAN), and styrene-butadiene block copolymers (SBC), and virgin lubricants B2, selected from fatty acids, fatty acid esters, fatty acid salts, fatty acid amides and hydrocarbon waxes.

The preferred embodiments of the virgin material B and the recycled acrylonitrile-butadiene-styrene copolymer (rABS) as described above in connection with the inventive thermoplastic recycling molding composition are applied accordingly.

In particular the key properties are mechanical, thermal and flow properties, more preferably the key properties are one or more selected from KP1 to KP8:
KP1 Melt volume flow rate (MVR) in cm³/10 min, measured on a polymer melt at 220° C. and 10 kg load according to ISO 1133-1:2011;
KP2 Vicat temperature in ° C., Vicat B/50 measured according to ISO 306:2004;
KP3 Elasticity modulus (E-modulus) in MPa, measured in accordance with ISO 527 (e.g. on a Zwick tensile tester with 2.5 kN+500 N);
KP4 Stress at yield in MPa and strain at yield in %, measured in accordance with ISO 527 (e.g. on a Zwick tensile tester with 2.5 kN+500 N);
KP5 Strain at yield in %, measured in accordance with ISO 527 (e.g. on a Zwick tensile tester with 2.5 kN+500 N);
KP6 Elongation at break in %, measured in accordance with ISO 527 (e.g. on a Zwick tensile tester with 2.5 kN+500 N);
KP7 Charpy Notched Impact Strength in kJ/m², measured in accordance with EN-ISO 179-1, notch type A;
KP8 Charpy Notched Impact Strength at −30° C. in kJ/m², measured in accordance with EN-ISO 179-1, notch type A.

Preferably at least 4, more preferably at least 6, most preferably all key properties, selected from KP1 to KP8 are used in the inventive process.

In particular the target properties TP of the recycling polymer composition are selected from the properties KP1 to KP8 as mentioned above.

More preferably the key properties KP and the target properties TP are at least four, preferably at least six, properties selected from melt volume flow rate (measured according to ISO 1133-1:2011, 220° C./10 kg), Vicat temperature (measured according to ISO 306:2004), elasticity modulus (measured according to ISO 527), stress at yield (measured according ISO 527), strain at yield (measured according to ISO 527), elongation at break (measured according to ISO 527), Charpy notched impact strength (measured according to EN-ISO 179-1A) and Charpy notched impact strength at −30° C. (measured according to EN-ISO 179-1A).

Preferably, the pre-defined ranges of target properties TP are one or more selected from the following:
TP1—Melt volume flow rate (MVR) (measured on a polymer melt at 220° C. and 10 kg load according to ISO 1133-1:2011) in the range of 10 to 35 cm³/10 min,
TP2 Vicat temperature (Vicat B/50 measured according to ISO 306:2004) of more than 80° C., preferably in the range of 90 to 100° C.,
TP3 E-modulus (measured in accordance with ISO 527) of more than 1500 MPa, preferably more than 1600 MPa;
TP4 Stress at yield (measured in accordance with ISO 527) in the range of 30 to 50 MPa,
TP5 Strain at yield (measured in accordance with ISO 527) in the range of 2 to 3 %,
TP6 Elongation at break (measured in accordance with ISO 527) in the range of 5 to 15%,
TP7 Charpy Notched Impact Strength at 23° C. (measured in accordance with EN-ISO 179-1, notch type A) in the range of 15 to 25 kJ/m²,
TP8 Charpy Notched Impact Strength at −30° C. (measured in accordance with EN-ISO 179-1, notch type A) in the range of 4 to 10 kJ/m².

Preferably, step d of the inventive process encompasses mixing of the virgin material B as determined in step c and the batch of recycled acrylonitrile-butadiene-styrene copolymer (rABS) in molten state, in particular at a temperature in the range of 180 to 280° C., preferably 200 to 250° C. Mixing of the polymer components may be obtained by the usual methods of plastic technology, for example using extruders, or other conventional kneading apparatuses, such as continuous or batch kneaders, Brabender mixers or Banbury mixers.

The present invention is illustrated by the following examples and claims.

### EXAMPLES

1. Preparation of recycling polymer compositions (Screening)

The following components are used in the examples:

Component A:

Recycled ABS, prepared from post-consumer products, e.g. of Waste Electrical and Electronic Equipment (VVEEE), end of life vehicles (ELV) and/or household waste.

Components B (all virgin materials):

B1_1 ABS product Novodur® VLK from INEOS Styrolution

B1_2 SAN product Luran® 2560 from INEOS Styrolution

B1_3 SBC product Styroflex® 2G66 from INEOS Styrolution

B2_1 Ethylene bis(stearylamide) (EBS)

B2_2 Pentaerythrityl tetrastearate (PETS).

About 60 polymer compositions were prepared and tested using a High-Throughput-Screening-System based on Design of Experiment (DoE) wherein the design as summarized in table 1 below were applied.

TABLE 1
Design of Experiments

| Settings | | | | |
|---|---|---|---|---|
| Model | | Targed | | Pre-defined |
| terms | Range | property | Unit | range |
| B1_1/ABS | 0-0.75 | EModulus | MPa | >1600 |
| B1_2/SAN | 0-0.3 | Yield strength | MPa | >32 |
| B1_3/SBC | 0-0.05 | Yield strain | % | 2-3 |
| B2_1/EBS | 0-0.1 | Elongation @B | % | 5-15 |
| B2_2/PETS | 0-0.005 | Notch imp. | kJ/m² | >17 |
| | | (23° C.) | | |
| SUM | 0.1-0.75 | Notch imp. | kJ/m² | >5 |
| | | (−30° C.) | | |
| rABS | 0.25-1.0 | MVR | cm³/10 min | 20-27 |
| | | Vicat | ° C. | 90-100 |

2. Test Methods

The following test methods were used in order to characterize the polymer compositions according to example 1 or the test moldings prepared therefrom.

a. Melt Volume Flow Rate (MVR)

MVR measured on a polymer melt at 220° C. and 10 kg load according to ISO 1133-1:2011).

b. Mechanical Properties

Specimen for tensile test, notches impact tests and Vicat temperature were produced via injection molding at 220° C., a screw rotational speed of 500 mm/s, injection speed of 100 mm/s, injection pressure of 1500 bar and cooling time of 50 s at 25° C. Subsequently, the specimens were conditioned at for 24h at 23° C.

Tensile test (stress and strain at yield, E-modulus and elongation at break) were measured on a Zwick tensile tester (2.5 kN+500 N) according to ISO 527. For this, samples were prepared according to the 1A shape specified in the standard.

The Vicat Temperature (Vicat B/50) was determined according to IS0306:2004 using 1 kg.

Charpy Notched Impact Strength at 23° C. and at −30° C., where measured in accordance with EN-ISO 179-1, notch type A. The type of break is indicated with C (complete break), H (hinge break), P (partial break), N (non-break/no valid result).

3. Results

The pure components rABS (A1) and ABS (B1_1) show the following properties:

TABLE 2
Properties of ABS (B1_1) and rABS (A)

| | | rABS | ABS |
|---|---|---|---|
| EModulus | MPa | 2461 | 1409 |
| Yield strength | MPa | 41.66 | 31.0 |
| Yield strain | % | 2.34 | 3.2 |
| Elongation @B | % | 6.86 | 19.0 |
| Notch imp. | kJ/m² | 3.26 (C) | 37.4 (H) |
| (23° C.) | | | |
| Notch imp. | kJ/m² | 2.72 (C) | 28.0 (H) |
| (−30° C.) | | | |
| MVR | cm³/10 min | 28.3 | 2.5 |
| Vicat | ° C. | 95.7 | 82.7 |

The scaled and centered coefficients for the notched impact strength, the melt volume flow rate MVR and the Vicat temperature as obtained from the DoE scanning procedure described in example 2 are summarized in the following table 3.

TABLE 3
Scaled and centered coefficients

| | Not. Impact | | | |
|---|---|---|---|---|
| | Strength | | MVR | Vicat B/50 |
| ABS | 0.37 | | −23 | −3.1 |
| SAN | −0.04 | | 8 | 1.6 |
| EBS | ns* | | 14 | −2.0 |
| SBC | 0.05 | | 6 | −3.0 |
| PETS | ns | | 1 (ns) | −0.75 |
| ABS*ABS | −0.025 | (ns) | 2 (ns) | −0.7 |
| SAN*SAN | −0.02 | (ns) | 4 | 0.5 |
| EBS*EBS | 0.03 | | — | — |
| PETS*PETS | — | | 2 (ns) | 0.5 |
| SBC*SBC | — | | — | −1.0 |
| ABS*SAN | 0.02 | | −4 | 0.75 |
| ABS*SBC | 0.01 | (ns) | −3 | — |
| ABS*EBS | — | | −8 | — |
| ABS*PETS | −0.01 | (ns) | — | −0.3 |
| SAN*SBC | −0.02 | | 0.5 (ns) | 0.75 |
| SBC*PETS | −0.1 | (ns) | 3 | 0.25 (ns) |

| | | | |
|---|---|---|---|
| SAN*EBS | — | 3 | — |
| SAN*PETS | | 1 (ns) | — |
| EBS*SBC | — | 3 | — |
| EBS*PETS | | 2 (ns) | — |

*non significant (ns) model term

Typically, a significant model term is given if the coefficient is greater than the error bar, a non-significant model term is given if the coefficient is smaller than the error bar. Even if a model term is non-significant taken separately it might be significant in combination with another model term. Typically, positive coefficients show that the corresponding model term increases the key property. Negative coefficients show that the corresponding model term decreases the key property.

The following results have been found:
ABS exhibits the largest positive impact on notched impact strength;
ABS exhibits the largest impact on MVR, wherein the MVR is decreased;
SAN, SBC and EBS exhibit significant impact on MVR wherein the MVR is increased;
A combination of ABS/SAN and ABS/EBS results in decreased MVR;
ABS, SBC and EBS exhibit significant impact on Vicat temperature wherein Vicat temperature is decreased;
SAN exhibits significant impact on Vicat temperature wherein Vicat temperature is increased

The compositions and their properties as summarized in Table 4 were predicted.

TABLE 4
Predicted compositions

| | Unit | Ex.1 | Ex.2 | Ex. 3 | Ex.4 |
|---|---|---|---|---|---|
| ABS | % by weight | 52.75 | 52.86 | 47.60 | 51.00 |
| SAN | % by weight | 15.99 | 13.39 | 17.80 | 18.00 |
| SBC | % by weight | 1.20 | 5.50 | 10.00 | 0.90 |
| EBS | % by weight | 4.98 | 3.27 | 0.50 | 5.00 |
| rABS | % by weight | 25.08 | 24.98 | 25.00 | 25.00 |
| EModulus | MPa | 1795.3 | 1686.1 | 1675.9 | 1848.2 |
| Yield strength | MPa | 33.27 | 32.66 | 34.38 | 33.90 |
| Yield strain | % | 2.4 | 2.6 | 2.8 | 2.4 |
| Elongation @B | % | 8.8 | 11.3 | 14.4 | 8.5 |
| Notch imp. | kJ/m² | 19.0 | 19.8 | 18.7 | 17.8 |
| (23° C.) | | | | | |
| Notch imp. | kJ/m² | 6.4 | 6.2 | 5.1 | 6.1 |
| (−30° C.) | | | | | |
| MVR | cm³/10 min | 24.3 | 22.7 | 23.2 | 26.3 |
| Vicat | ° C. | 87.7 | 86.6 | 86.8 | 88.3 |

Example 3 from table 4 shows the synergistic effect of the component SBC. Compositions with 10% by weight SBC shows an improved the elongation at break of 14.4%. The elongation at break is an important criterion for toughness/ductility of the ABS blends.

The maximum of 14.4% elongation at break is more than the linear prediction model as shown in the following table, as SBC is not miscible with ABS:

| | Elongation at break | % by weight in blend of example 3 |
|---|---|---|
| r-ABS | 6.9% | 25 |
| ABC | 19.0 | 47.6 |
| SAN | 2% (literature) | 17.8 |

Based on the measured values given above, the calculated average for the elongation at break for the composition of example Ex. 3 is 12.4%.

1-15. (canceled)

16. A thermoplastic recycling molding composition comprising:
a. 10 to 90% by weight, based on the total composition, of at least one recycled acrylonitrile-butadiene-styrene copolymer as component A; and
b. 10 to 90% by weight, based on the total composition, of virgin material as component B, wherein the component B is a mixture of at least two components selected from virgin thermoplastic polymers B1 and virgin lubricants B2, or wherein the virgin material B comprises one or more polymers which are nonhomogenously miscible with the recycled acrylonitrile-butadiene-styrene copolymer,
wherein the virgin thermoplastic polymers B1 is selected from acrylonitrile-butadiene-styrene copolymers, styrene-acrylonitrile copolymers, and styrene-butadiene block copolymers, and the virgin lubricants B2 is selected from fatty acids, salts of fatty acids, fatty acid esters, fatty acid amide derivatives and hydrocarbon waxes; and the virgin material B comprises at least one styrene-acrylonitrile copolymer (SAN).

17. The thermoplastic recycling molding composition of claim 16, comprising 30 to 80% by weight, based on the total composition, of component A, and 20 to 70% by weight, based on the total composition, of component B.

18. The thermoplastic recycling molding composition of claim 16, wherein the at least one recycled ABS is a recycling material obtained from the recycling of durable goods.

19. The thermoplastic recycling molding composition of claim 17, wherein the durable goods are post-consumer durable goods.

20. The thermoplastic recycling molding composition of claim 16, wherein the virgin material B comprises one or more polymers which are non-homogenously miscible with the recycled acrylonitrile-butadiene-styrene copolymer, and which are selected from styrene-butadiene block copolymers.

21. The thermoplastic recycling molding composition of claim 16, wherein the virgin material B comprises at least one virgin thermoplastic polymer B1 and at least one virgin lubricant B2.

22. The thermoplastic recycling molding composition of claim 16, wherein the virgin material B is a mixture of at least one virgin acrylonitrile-butadiene-styrene copolymer and at least one other component B selected from virgin styrene-acrylonitrile copolymers, virgin styrene-butadiene block copolymers (SBC), and least one virgin lubricant B2 selected from fatty acids, salts of fatty acids, fatty acid esters, fatty acid amide derivatives, and hydrocarbon waxes.

23. The thermoplastic recycling molding composition of claim 16, wherein the virgin material B is a mixture of virgin acrylonitrile-butadiene-styrene copolymer (ABS), virgin styrene-acrylonitrile copolymers (SAN), virgin styrene-butadiene block copolymers (SBC), and at least one virgin lubricant B2.

24. The thermoplastic recycling molding composition of claim 16, wherein the virgin material B comprises from 10 to 80% by weight, based on the total virgin material B, of at least one virgin acrylonitrile-butadiene-styrene copolymer (ABS).

25. The thermoplastic recycling molding composition of claim 16, wherein the virgin material B comprises from 50 to 75% by weight, based on the total virgin material B, of at least one virgin acrylonitrile-butadiene-styrene copolymer (ABS).

26. The thermoplastic recycling molding composition of claim 16, wherein the virgin lubricant B2 is selected from fatty acid esters and fatty acid amide derivatives.

27. The thermoplastic recycling molding composition of claim 16, wherein the virgin material B comprises ethylene-bis-stearylamide (EBS) as component B2, in an amount from 0.1 to 8% by weight, based on the total virgin material B.

28. The thermoplastic recycling molding composition of claim 16, wherein the virgin material B is a mixture of at least two components of:
from 0 to 80% by weight, based on the total virgin material B, of at least one virgin acrylonitrile-butadiene-styrene copolymer (ABS);
from 0 to 30% by weight, based on the total virgin material B, of at least one virgin styrene-acrylonitrile copolymers (SAN);
from 0 to 20% by weight, based on the total virgin material B, of at least one styrene-butadiene block copolymers (SBC); and
from 0 to 8% by weight, based on the total virgin material B, of at least one virgin lubricant B2.

29. The thermoplastic recycling molding composition of claim 16 wherein the thermoplastic recycling molding composition comprises:
from 40 to 80% by weight, based on the total composition, of at least one recycled acrylonitrile-butadiene-styrene copolymer (rABS);
from 10 to 50% by weight, based on the total composition, of at least one virgin acrylonitrile-butadiene-styrene copolymer (ABS);
from 1 to 20% by weight, based on the total composition, of at least one virgin styrene-acrylonitrile copolymer (SAN);
from 0 to 20% by weight, based on the total composition, of at least one styrene-butadiene block copolymer (SBC);
from 1 to 5% by weight, based on the total composition, of at least one virgin lubricant B2; and
from 0 to 5% by weight, based on the total composition, of one or more additive C.

30. The thermoplastic recycling molding composition of claim 16, wherein the molding composition comprises:
from 19.4 to 39.4% by weight, based on the total composition, of at least one recycled acrylonitrile-butadiene-styrene copolymer;
from 30 to 75% by weight, based on the total composition, of at least one virgin acrylonitrile-butadiene-styrene copolymer;
from 5 to 25% by weight, based on the total composition, of at least one virgin styrene-acrylonitrile copolymer;
from 0.5 to 15% by weight, based on the total composition, of at least one styrene-butadiene block copolymer;
from 0.1 to 7% by weight, based on the total composition, of at least one virgin lubricant B2; and
from 0 to 5% by weight, based on the total composition, of one or more additive C.

31. The thermoplastic recycling molding composition of claim 30, wherein the molding composition comprises:
from 20 to 30% by weight, based on the total composition, of at least one recycled acrylonitrile-butadiene-styrene copolymer;
from 40 to 60% by weight, based on the total composition, of at least one virgin acrylonitrile-butadiene-styrene copolymer;
from 10 to 20% by weight, based on the total composition, of at least one virgin styrene-acrylonitrile copolymer;
from 1 to 10% by weight, based on the total composition, of at least one styrene butadiene block copolymer;
from 0.5 to 5% by weight, based on the total composition, of at least one virgin lubricant B2; and
from 0 to 2% by weight, based on the total composition, of one or more additive C.

32. The thermoplastic recycling molding composition of claim 30, wherein the at least one virgin lubricant B2 is selected from ethylene bis(stearylamide) and pentaerythrityl tetrastearate.

33. A process for preparing the thermoplastic recycling molding composition of claim 16, wherein the components A and B and optionally C are melt compounded at a temperature in the range of 180 to 280° C.

34. A molding made of the thermoplastic recycling molding composition of claim 16.

35. A process for preparing a recycling polymer composition comprising at least one recycled acrylonitrile-butadiene-styrene copolymer and a virgin material B, wherein the virgin material B is a mixture of at least two components selected from virgin thermoplastic polymers B1 and virgin lubricants B2, or wherein the virgin material B comprises one or more polymers which are non-homogenously miscible with the recycled acrylonitrile-butadiene-styrene copolymer, comprising the steps of:
a. homogenization of the at least one recycled acrylonitrile-butadiene-styrene copolymer, wherein a batch of recycled acrylonitrile-butadiene-styrene copolymer is obtained;
b. measurement of at least one key property of the batch of acrylonitrile-butadiene-styrene copolymer;
c. determination of the amount and composition of the virgin material B based on predefined ranges of target properties of the recycling polymer composition using a screening method based on Design of Experiment; and
d. mixing the virgin material B as determined in step c and the batch of recycled acrylonitrile-butadiene-styrene copolymer,
wherein the recycling polymer composition is a recycling molding composition of claim 16.
